(19) United States
(12) Patent Application Publication
(10) Pub. No.: US 2012/0013031 A1
(43) Pub. Date: Jan. 19, 2012

(54) Mould Comprising Two Internal Corner-Cubes and Component Comprising Cuboid Elements Forming Two Internal Corner-Cubes

(75) Inventors: Paul David Mason, Worcestershire (GB); David Arthur Orchard, Worcestershire (GB); Andrew Maxwell Scott, Worcestershire (GB)

(73) Assignee: QINETIQ LIMITED

(21) Appl. No.: 12/672,804

(22) PCT Filed: Aug. 4, 2008
(86) PCT No.: PCT/GB08/02658

§ 371 Date: Feb. 9, 2010

(30) Foreign Application Priority Data
Aug. 10, 2007 (GB) 0715632.6

(51) Int. Cl. B29D 11/00; B28B 1/14; B28B 7/36

(52) U.S. Cl. 264/2.6; 249/114.1; 264/299

(57) ABSTRACT

The invention provides a mould (80) comprising first (82), second (84) and third (86) cuboid moulds elements, each having a pair of adjacent rectangular faces which are planar and polished flat and which intersect at 270° to a high tolerance. Each mould element has a length dimension substantially twice its width dimension so that the mould elements may be arranged to form two accurate internal corner-cubes having flat, planar surfaces suitable for moulding. The apexes of the two internal corner-cubes are co-located. Pairs of adjacent mould elements are clamped in contact with each other by means of bolts (88) and washers (89). The mould may be used to produce a component having a very accurate solid corner-cube, whilst the mould elements themselves are relatively simple to fabricate because each is required to have only a pair of adjacent rectangular surfaces which are flat and planar and which intersect at 270° to a high tolerance.

The invention relates to moulds for use in production of components having external (solid) corner-cubes and to methods of making such moulds. It also relates to components, for example optical components, having internal (hollow) corner cubes and to methods of making such components.

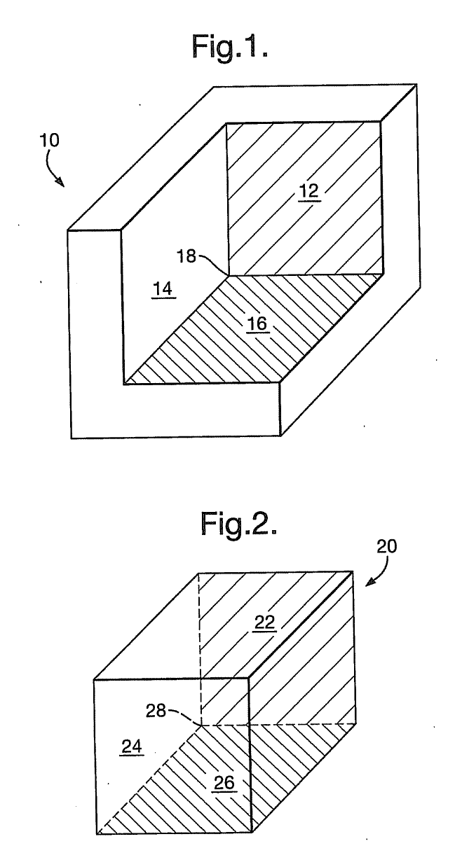

To clarify nomenclature, in this specification an “internal corner cube”, or “hollow corner-cube”, means an object like that indicated generally by 10 in FIG. 1. The object 10 has three substantially mutually perpendicular flat, planar surfaces 12, 14, 16 defining an apex 18 which is absent any solid material. An “external corner-cube”, or “solid corner cube”, means an object like that indicated generally by 20 in FIG. 2. The solid object 20 also has three mutually perpendicular flat, planar surfaces 22, 24, 26, but in contrast to the object 10 in FIG. 1, the surfaces 22, 24, 26 define an apex 28 of solid material.

Certain optical components are required to have three flat, planar surfaces which are substantially mutually perpendicular to a high tolerance and form a solid or hollow corner-cube. For example, a solid glass corner-cube reflector is required to have three such surfaces forming a solid corner-cube, wherein adjacent surfaces intersect at 90° to a tolerance of four arc seconds or better. The corner-cube in such a reflector may be an external, or solid, corner cube, in which case in use one or more of the flat, planar surfaces retro-reflects light back into the body of the reflector. Alternatively, the corner-cube may be an internal, or hollow corner-cube, whereby light from free-space is retro-reflected back into free space. In either case the surfaces may be coated to increase reflectivity.

Components having solid or hollow corner-cubes are generally produced by a lengthy cutting and polishing process which results in a high unit cost both for the components hence also for systems and devices into which they are incorporated. Even after careful polishing, bevels exist between pairs of adjacent flat, planar surfaces; these degrade performance in certain applications, for example when the component is used as a corner-cube reflector. The fabrication of a component having an internal (hollow) corner-cube (for example for use as a hollow corner-cube reflector) is especially difficult due to the inaccessibility of surfaces to be polished.

Components having solid corner-cubes may be produced by moulding (e.g. U.S. Pat. Nos. 1,591,572 and 3,417,959) however the known moulds involve production of mould elements also having three mutually perpendicular surfaces forming a solid corner-cube. Thus, whilst allowing mass production of components having solid corner-cubes, production of such mould elements involves the same difficulties as making a finished component having a solid corner-cube by cutting and polishing techniques.

A first aspect of the invention provides a mould comprising first, second and third substantially cuboid mould elements each having a pair of adjacent substantially rectangular faces which are flat and planar and which intersect at an angle of substantially 270°, the mould elements being arranged such that first and second such faces of a first mould element are in contact with a flat, planar face of a second mould element and a flat, planar face of a third mould element respectively, whereby said faces of the mould elements are moulding surfaces and form two internal corner-cubes having their apexes co-located.

A mould of the invention has the advantage that it may be used to produce a component having an accurate solid corner-cube, but is composed of mould elements each of which is required to have only two adjacent surfaces which are flat and planar and which intersect at 270°, instead of three such surfaces. Production of the mould is therefore considerably simplified with respect to the prior art moulds, but without sacrificing accuracy in the corner-cube of a moulded component made using the mould.

To further simplify production of the mould elements, preferably these elements are substantially identical cuboids, each rectangular cuboid face having a length dimension substantially twice its width dimension.

When the mould elements are placed in contact, dust trapped between contacting surfaces may result in misalignment of the mould elements. The effects of dust trapping may be mitigated by providing each of the flat, planar surfaces of any given mould element with a central recess, each recess being located on respective cubic half of the cuboid. By reducing the common area of contact between adjacent mould elements, the probability of dust being trapped in this area is reduced. If dust is trapped in this area, then misalignment is reduced because the dust is trapped towards the edge of the common contact area. If the mould elements are clamped together to form the mould, then the pressure exerted by one mould element on an adjacent element is increased for a given clamping force due the reduction in the common contact area; this improves the rigidity of the mould and provides for easier separation of the mould elements, should this be required.

The mould elements may be fused in contact, e.g. by application of heat and pressure. Alternatively, clamping means may be provided to clamp adjacent pairs of mould elements together to form the two internal corner-cubes. For example each pair of mould elements may be adapted to be clamped together by a nut and bolt arrangement. Preferably the bolt is made of a material having a lower coefficient of thermal expansion than that of the material of the mould elements so that when the mould is heated the mould elements remain rigidly clamped together. As an alternative, the bolt may be made of material having a higher coefficient of thermal expansion than that of the material of the mould elements, the clamping means further comprising a washer adapted to cooperate with the bolt, and the washer material having a coefficient of thermal expansion higher than that of the material of the bolt.

The mould is especially suitable for moulding glass if each of the mould elements is made of a material having a thermal conductivity of at least 10 Wm⁻¹K⁻¹. In general, the mould elements may be made from tungsten carbide, or silicon or silica for example. Tungsten carbide is particularly useful for moulding chalcogenide glasses because there is low adhesion between tungsten carbide and such glasses.

A second aspect of the invention provides a component, for example an optical component, comprising first, second and third substantially cuboid elements each having a pair of adjacent substantially rectangular faces which are flat and planar and which intersect at an angle of substantially 270°, the elements being arranged such that first and second such faces of a first element are in contact with a flat, planar surface of a second element and a flat, planar surface of a third element respectively, whereby said faces of the elements form two internal corner-cubes having their apexes co-located.

The component provides two accurate internal corner-cubes, but is made up from components each of which only requires a pair of adjacent faces which are flat and planar and which intersect at an angle of substantially 270°. Fabrication of the elements making up the component (and their subsequent assembly) is very much easier than fabrication of an internal corner-cube by cutting and polishing methods. Production of the elements of the component is simplified if they are substantially identical cuboids, each rectangular cuboid face having a length dimension substantially twice its width dimension.

Preferably the flat, planar surfaces of any given mould element each have a central recess, each recess being located on respective cubic half of the cuboid, for reasons discussed above.

The elements of the component may be fused in contact, for example if the elements are glass elements.

Parts of the flat, planar faces which form the internal corner-cubes may carry reflective coatings (e.g. metal or dielectric coatings) to provide or enhance reflectivity, if the component is intended for use as an internal (hollow) corner-cube reflector.

The elements could be clamped together to form the component. For example, pairs of elements could be clamped together with a nut and bolt arrangement as described above in relation to the mould of the invention.

According to a third aspect of the invention, there is provided a method of making a mould, the method comprising the steps of:
(i) producing three substantially cuboid mould elements;
(ii) processing the each of the mould elements such that each has a pair of adjacent substantially rectangular faces which are flat and planar and which intersect at an angle of substantially 270°; and
(iii) arranging the mould elements such that first and second such faces of a first mould element are in contact with a flat, planar surface of a second mould element and a flat, planar surface of a third mould element respectively, whereby said faces of the mould elements are moulding surfaces and form two internal corner-cubes having their apexes co-located.

A fourth aspect of the invention provides a method of making a component, for example an optical component, by corresponding steps.

A fifth aspect of the invention provides a method of making an external corner-cube comprising the steps of introducing a charge into a mould of the invention, heating the charge to form a softened charge and stamping the softened charge into an internal corner-cube of the mould in the general direction of an apex of the mould.

For example, the charge could be a glass charge so that a glass component having an external (solid) corner-cube results. When the softened glass charge is stamped in the general direction of the apex of one of the internal (hollow) corner-cubes of the mould, a surface of optical quality may be simultaneously formed on the side of the charge remote from the corner-cube, thus producing a window allowing light to reach the corner-cube. The surface of the window may be flat or curved, for example it may have spherical curvature. Also, the stamping process may provide a window having a textured surface so that the window provides an optical function. For example, it could be textured to provided an anti-reflection function. An example of such a textured surface is a so-called moth-eye anti-reflection surface. The stamping process may also be arranged to provide a peripheral raised edge to the window, allowing the finished corner-cube to be bonded to another component.

Embodiments of the invention are described below with reference to the accompanying drawings in which:

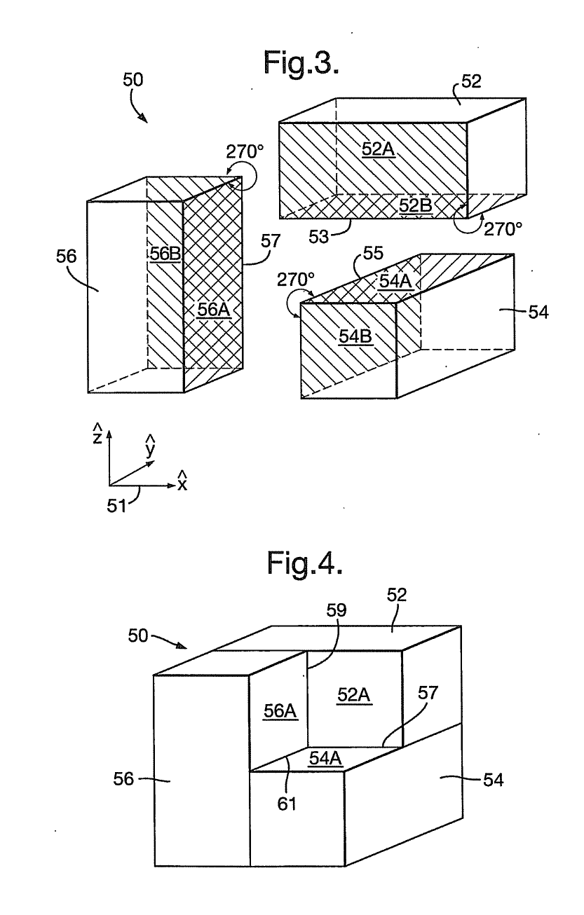

FIG. 3 shows a mould of the invention comprising three cuboid mould elements;

FIG. 4 shows the FIG. 3 mould elements arranged to form an internal corner-cube;

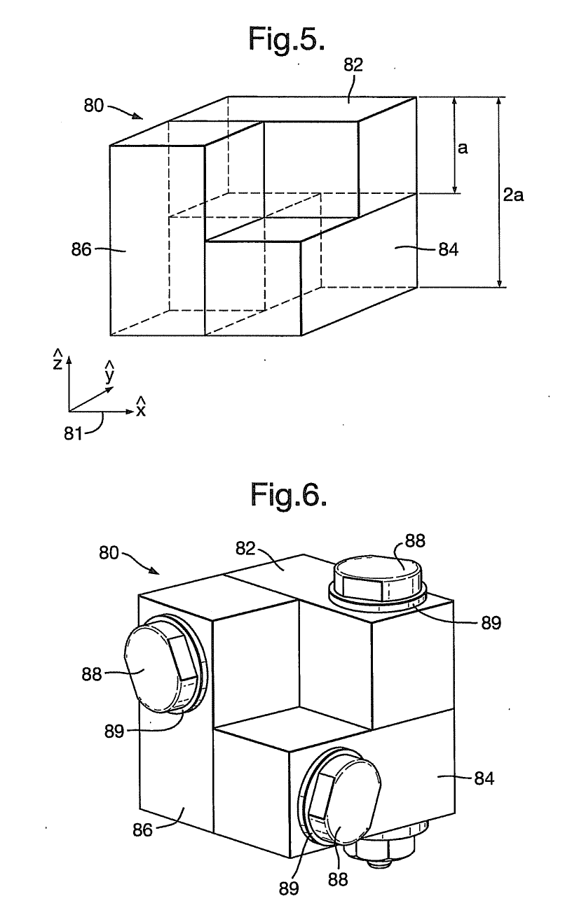

FIG. 5 shows a mould of the invention having two internal corner-cubes with co-located apexes;

FIG. 6 shows a clamping arrangement for the FIG. 5 mould elements;

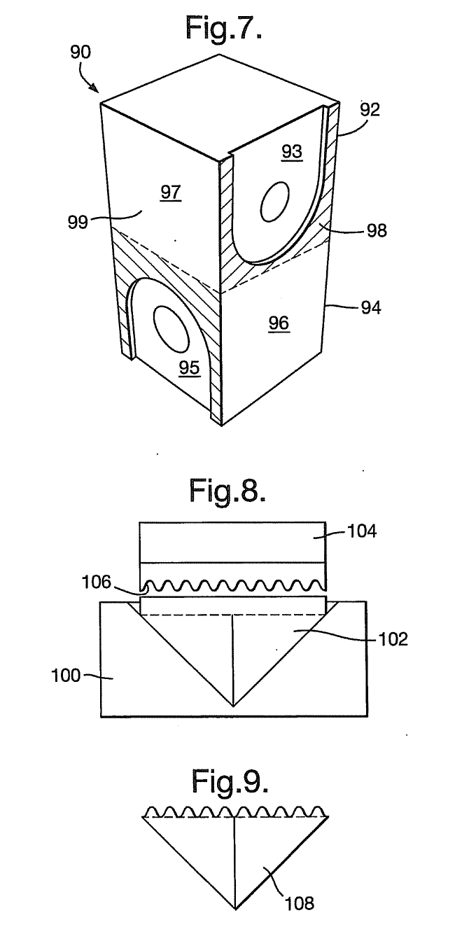

FIG. 7 shows an alternative mould element for use in the FIG. 6 mould; and

FIGS. 8 & 9 illustrate production of an external glass corner-cube having a surface pattern.

FIG. 3 shows an exploded view of a mould of the invention, indicated generally by 50, referred to rectangular coordinates 51. The mould 50 comprises first 52, second 54 and third 56 tungsten carbide mould elements. In FIG. 3, mould elements 52, 56 are shown spaced apart in the ŷ direction, mould elements 52, 54 are shown spaced apart in the \hat{z} direction and mould elements 54, 56 are shown spaced apart in the \hat{x} direction. Surfaces 52A, 52B of mould element 52 are polished to a flatness suitable for moulding planar glass surfaces of optical quality. Mould element 52 is formed so that surfaces 52A, 52B intersect at 270° to a tolerance of four arc seconds or better such that they form a solid right-angled corner 53 and are substantially mutually perpendicular. Although mould element 52 is shown in FIGS. 3 and 4 as being cuboid in shape, this is not essential and the surfaces other than 52A, 52B need not be planar or polished flat. Mould elements 54, 56 also have pairs of flat, planar surfaces 54A, 54B and 56A, 56B, the mould elements 54, 56 being polished such that surfaces 54A, 54B and 56A, 56B intersect at 270° to a tolerance of four arc seconds or better and are mutually perpendicular so that they form solid right-angled corners 55, 57 respectively. Although mould elements 54, 56 are shown in FIG. 3 as cuboids, surfaces other than 54A, 54B and 56A, 56B need not be planar or flat.

FIG. 4 shows the mould 50 in an assembled state. A first flat, planar surface of any given mould element is in contact with a flat, planar surface of a second mould element, and a second flat, planar surface of the first mould element is in contact with a flat, planar surface of a third mould element. For example, surfaces 52A, 52B of mould element 52 are in contact with surfaces 56B of mould element 56 and 54A of mould element 54, respectively. Surfaces 52A, 54A, 56A are substantially mutually perpendicular and provide an internal (hollow) corner-cube formed by right-angled corners 57, 59, 61. A solid glass corner cube may be produced by introducing a glass charge into one of the internal corner cubes of the mould 50, heating the charge so that it becomes softened, and then stamping the softened charge in the general direction of an apex of a hollow corner-cube presented by the mould 50. If the glass corner-cube is not required to have mutually perpendicular surfaces of optical quality, the flatness of the surfaces 52A, 54A, 56A may be reduced accordingly.

FIG. 5 shows another assembled mould of the invention, indicated generally by 80, comprising three mould elements 82, 84, 86. Each of the mould elements is cuboid in shape and has a length dimension substantially twice its width dimension. Each mould element has a pair of adjacent rectangular faces which are planar and polished flat to provide moulding surfaces, and which intersect at 270° with a tolerance or four arc seconds or better, such that each has a long edges presenting a solid right-angled corner. First and second moulding surfaces of a first mould element are in contact with a moulding surface of a second mould element and a moulding surface of a third mould element, respectively.

The assembled mould 80 has two internal (hollow) corner-cubes having moulding surfaces. The apexes of the internal corner-cubes are co-located. If the mould elements 82, 84, 86 have length 2a and width a, the assembled mould 80 has the form of a cube of side 2a having two smaller cubes of side a removed (thus forming the internal corner-cubes), the smaller cubes lying on a diagonal of the cube of side 2a. The mould 80 allows simultaneous moulding of two solid glass corner cubes.

FIG. 6 illustrates one scheme for clamping mould elements 82, 84, 86 together in which adjacent mould elements are clamped together using bolts 89 and fastening nuts (not shown). Any given mould element has two holes passing through it, one passing through each cubic half. The two holes passing through a mould element are substantially orthogonal and each is dimensioned to receive a bolt 88. Each mould element is clamped to two adjacent mould elements by respective bolts 88 and fastening nuts. The bolts 88 are made of a material having a coefficient of thermal expansion greater than that of the mould elements 82, 84, 86. The bolts 88 are provided with washers 89 made of a material having a higher coefficient of thermal expansion than that of the material of the bolts 88 so that the mould elements 82, 84, 86 remain firmly clamped together when the mould 80 is heated. Alternatively, the bolts 88 may be made of a material having a coefficient of thermal expansion less than that of the material of the mould elements, obviating the need for washers.

FIG. 7 shows an alternative mould element 90, three of which may be used to assemble the mould 80 of FIG. 6. The mould element 90 has a form substantially the same as each of the mould elements 82, 84, 86 except that the mould element 90 has two central recesses 93, 95 on respective adjacent rectangular faces 98, 99, and on respective cubic halves 92, 94 of the mould element 90. To assemble the mould 80, the recessed square half of the rectangular face 99 of the mould element 90 is placed in contact with the recessed square half of a rectangular face of a second such mould element such that the two mould elements are orthogonal. Similarly, the recessed square half of the rectangular face 98 of the mould element 90 is placed in contact with the recessed square half of a rectangular face of a third such mould element such that these two mould elements are orthogonal. The non-recessed square halves 96, 97 of the adjacent rectangular faces 98, 99 each become one side of a respective internal corner cube of the mould 80. The recesses 93, 95 reduce the common area of contact between adjacent mould elements, thus reducing the possibility that particles of dust or dirt become trapped between adjacent mould elements when the mould 80 is assembled, thus misaligning the mould elements and reducing the orthogonality of the corner-cubes. The shape of the recesses may vary from that shown in FIG. 7, however the non-recessed portions (shown shaded in FIG. 7) of the square halves of the rectangular faces having the recesses must be shaped such that surfaces of the elements forming the corner cube are mutually orthogonal.

Referring to FIGS. 8 and 9, a mould 100 of the invention having an internal (hollow) corner-cube contains a softened glass charge 102. A stamping element 104 having a corrugated stamping surface 106 is used to stamp the charge 102 into the corner cube, to produce a solid glass corner cube 108 having an anti-reflection surface, such as a moth-eye surface. A solid glass corner-cube having a desired surface pattern may therefore be produced in a single step using a mould of the invention.

The moulds of FIGS. 4, 5 and 6 may be adapted for use as internal corner-cube reflectors. For example, metal or dielectric reflective coatings may be applied to the surfaces 52A, 54A, 56A of the mould 50 of FIG. 4. If both internal corner-cubes are provided with reflective coatings, then two internal corner-cube reflectors are produced, the reflectors having apexes which are exactly co-located. Such an arrangement is useful in certain interferometric techniques.

A monolithic glass component having two internal corner-cubes may be produced by taking three glass elements equivalent to the mould elements 52, 54, 56 of FIG. 3 and fusing them together using heat and pressure to produce a monolithic glass component having the form of the assembled mould 50 of FIG. 5. The surfaces forming the internal corner-cube may be coated to enhance reflectivity if required. In order to avoid misalignment caused by trapping of dust or dirt prior to fusing, the glass elements may be provided with central recesses as shown in FIG. 7.

1. A mould comprising a component according to claim 12.

2-6. (canceled)

7. A component according to claim 20 wherein the bolt is made of a material having a lower coefficient of thermal expansion than that of the material of the mould elements.

8. A component according to claim 20 wherein the bolt is made of material having a higher coefficient of thermal expansion than that of the material of the mould elements and wherein the clamping means further comprises a washer adapted to cooperate with the bolt, the washer material having a coefficient of thermal expansion higher than that of the material of the bolt.

9. A component according to claim 12 wherein each of the mould elements is made of a material having a thermal conductivity of at least 10 Wm⁻¹K⁻¹.

10. A component according to claim 12 wherein each of the mould elements is made of a material having a coefficient of thermal expansion less than or equal to that of a glass material.

11. (canceled)

12. A component comprising first, second and third substantially cuboid elements each having a pair of adjacent substantially rectangular faces which are flat and planar and which intersect at an angle of substantially 270°, the elements being arranged such that first and second such faces of a first element are in contact with a flat, planar surface of a second element and a flat, planar surface of a third element respectively, whereby said faces of the elements form two internal corner-cubes having their apexes co-located.

13. A component according to claim 12 wherein the elements are substantially identical cuboids, each rectangular cuboid face having a length dimension substantially twice its width dimension.

14. A component according to claim 13 wherein the flat, planar surfaces of any given element each have a central recess, each recess being located on respective cubic half of the cuboid.

15. A component according to claim 12 wherein the elements are fused in contact to form the two internal corner-cubes.

16. A component according to claim 15 wherein the elements are glass elements.

17. A component according to claim 12 wherein the parts of said faces forming said internal corner-cubes carry reflective coatings.

18. A component according to claim 12 wherein the reflective coatings are metal coatings or dielectric coatings.

19. A component according to claim 12 further comprising clamping means for clamping the elements together to fatal the two internal corner-cubes.

20. A component according to claim 19 wherein the clamping means comprises a bolt for clamping a pair of elements together, and each of the pair of mould elements is adapted to receive the bolt and to be clamped together by the bolt.

21. A component according to claim 19 wherein each of the elements is made of tungsten carbide, or silicon, or silica.

22-23. (canceled)

24. A component according to claim 12 wherein the internal corner-cubes are corner-cube reflectors.

25-27. (canceled)

28. A method of making a component comprising the steps of:
(i) producing three substantially cuboid elements;
(ii) processing the each of the elements such that each has a pair of adjacent substantially rectangular faces which are flat and planar and which intersect at an angle of substantially 270°; and
(iii) arranging the elements such that first and second such faces of a first element are in contact with a flat, planar surface of a second element and a flat, planar surface of a third element respectively, whereby said faces of the elements form two internal corner-cubes having their apexes co-located.

29-31. (canceled)

32. A method of making an external corner-cube comprising the steps of introducing a charge into a mould including a first, second and third substantially cuboid elements each having a pair of adjacent substantially rectangular faces which are flat and planar and which intersect at an angle of substantially 270°, the elements being arranged such that first and second such faces of a first element are in contact with a flat, planar surface of a second element and a flat, planar surface of a third element respectively, whereby said faces of the elements form two internal corner-cubes having their apexes co-located, or into a mould made by a method according to claim 28, heating the charge to form a softened charge and stamping the softened charge into an internal corner-cube of the mould in the general direction of an apex of the mould.

33. A method according to claim 32, wherein the charge is a glass charge and the resulting external corner-cube is an external glass corner-cube.

34. A method of making a glass corner-cube reflector comprising the steps of making an external glass corner-cube by the method of claim 33 and optionally coating the three mutually perpendicular faces of the resulting external glass corner-cube with a reflective coating, preferably a reflective coating of metal or dielectric and wherein the softened glass charge is optionally stamped so as to produce a surface of optical quality on the side of the charge remote from the external corner-cube whereby an optical window is produced which allows light to pass to the resulting corner-cube reflector.

35. (canceled)

36. A method according to claim 34 wherein the softened glass charge is stamped such that said surface is one of flat, curved, and spherically curved.

37-38. (canceled)

39. A method according to claim 34 wherein the softened glass charge is stamped such that said surface is textured so as to provide an optical function.

40-41. (canceled)

42. A method according to claim 34 wherein the softened glass charge is stamped so that said surface is provided with a peripheral raised edge.
